(19) United States
(12) Patent Application Publication
(10) Pub. No.: US 2017/0096975 A1
(43) Pub. Date: Apr. 6, 2017

(54) HOLLOW INTAKE MANIFOLD

(71) Applicant: Oliver Matt Shurdim, Anaheim, CA (US)

(72) Inventor: Oliver Matt Shurdim, Anaheim, CA (US)

(21) Appl. No.: 15/382,512

(22) Filed: Dec. 16, 2016

(51) Int. Cl. F02M 35/104; F02M 35/10

(52) U.S. Cl. CPC F02M 35/104; F02M 35/10354; F02M 35/10222

(57) ABSTRACT

An intake manifold for an internal combustion engine having: at least one runner having a front side and a back side defining a hollow interior space, and a port for receiving air into the hollow interior space, the back side having a plurality of cylinder holes aligning with cylinder head openings of the internal combustion engine and a plurality of bolt holes configured for receiving a plurality of bolts, each bolt having a bolt head and a bolt thread, the front side having a plurality of access holes aligning with the plurality of bolt holes, the access holes being configured to allow a user to access and secure the bolt head using a bolt-securing tool, the access holes being further configured to receive a seal, such that the intake manifold can be secured to the internal combustion engine with no portion of the bolt thread lying within the hollow interior space of the intake manifold thus preventing obstruction of air circulation through the hollow interior space.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

1. Field of the Invention

The invention relates generally to engines and more specifically to the intake manifold of a vehicle engine.

2. Description of the Related Art

The intake manifold of a vehicle internal combustion engine is used to supply a mixture of fuel and air evenly to the engine cylinder heads. One of various methods of improving the engine power and performance is to improve air flow. During combustion, as a piston moves down, air resistance can cause loss of power. Poor engine performance can occur due to choking of air, high exhaust gas temperatures, or poor air flow. The prior art includes intake manifolds with pillars in the interior of the hollow manifold through which bolts can pass, for securing the manifold to the cylinders, which may lead to some obstruction of air. The prior art also includes intake manifolds with exhaust gas recirculation components for recirculation of some of the engine exhaust gas back to the cylinders. The placement of these components may be at least partially inside of the intake manifold, which also cause some obstruction of air on the interior of the manifold. These designs of such intake manifolds create more air resistance and thus, poor engine performance. Therefore, there is a need for an intake manifold with improved air flow, for better performance and efficiency of the vehicle's engine.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect an intake manifold is provided in which interior pillars are removed and connected to the intake manifold on the exterior of the part only. Thus, an advantage is a larger inner volume for air flow, which may allow for better engine efficiency, and better cooling of the exhaust.

In another aspect, the exhaust gas recirculation (EGR) components are not provided with the hollow intake manifold. Thus, an advantage is that more air volume is allowed inside of the hollow intake manifold, which may allow for a cleaner and more efficiently running vehicle.

In another aspect, a hollow intake manifold is provided, having exhaust gas recirculation components. Thus, an advantage is that the intake manifold may make use of the EGR recirculation while removing some obstructions from the interior of the manifold, and result in some improvement in engine performance.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates the front view of a hollow intake manifold, and an intake manifold 101 as known in the art, according to an aspect.

FIGS. 2a-2b show a front view and a front perspective view, respectively, of an intake manifold as known in the art, according to an aspect.

FIGS. 3a-3b show two examples of sectional views of an intake manifold as known in the art, according to an aspect.

FIG. 4 shows a front perspective view of a hollow intake manifold, according to an aspect.

FIGS. 5a-5b show a perspective sectional view and a sectional view, respectively, of a hollow intake manifold, according to an aspect.

FIGS. 5c-5d show a perspective view and a detailed view, respectively, of a hollow intake manifold with its runner cut open, displaying the interior, according to an aspect.

FIG. 5e shows a detailed front perspective view of one of the hollow intake manifold's runners, according to an aspect.

FIG. 6 illustrates the front plan view of another example of a hollow intake manifold, according to an aspect.

FIG. 7 illustrates the top elevation view of the hollow intake manifold of FIG. 6, according to an aspect.

FIG. 8 illustrates the bottom elevation view of the hollow intake manifold of FIG. 6, according to an aspect.

FIG. 9 illustrates the left side perspective view of the hollow intake manifold of FIG. 6, according to an aspect.

FIG. 10 illustrates the left side elevation view of the hollow intake manifold of FIG. 6, according to an aspect.

FIG. 11 illustrates the right side perspective view of the hollow intake manifold of FIG. 6, according to an aspect.

FIG. 12 illustrates the back right perspective view of the hollow intake manifold of FIG. 6, according to an aspect.

FIG. 13 illustrates the back plan view of the hollow intake manifold of FIG. 6, according to an aspect.

FIG. 14 illustrates the back left perspective view of the hollow intake manifold of FIG. 6, according to an aspect.

FIG. 15 shows a front perspective view of another example of a hollow intake manifold, according to an aspect.

FIG. 16 shows the left side perspective view of the hollow intake manifold of FIG. 15, according to an aspect.

FIG. 17 shows the back perspective view of the hollow intake manifold of FIG. 15, according to an aspect.

FIG. 18 shows the front top perspective view of the hollow intake manifold of FIG. 15, according to an aspect.

FIG. 19 shows the front side perspective view of the hollow intake manifold of FIG. 15, according to an aspect.

FIG. 20 shows the back side perspective view of the hollow intake manifold of FIG. 15, according to an aspect.

FIG. 21 shows the left side elevation view of the hollow intake manifold of FIG. 15, according to an aspect.

FIG. 22 shows the horizontal sectional view of the hollow intake manifold of FIG. 15, showing the inner floor, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

For the following description, it can be assumed that most correspondingly labeled elements across the figures (e.g., 100 and 400, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

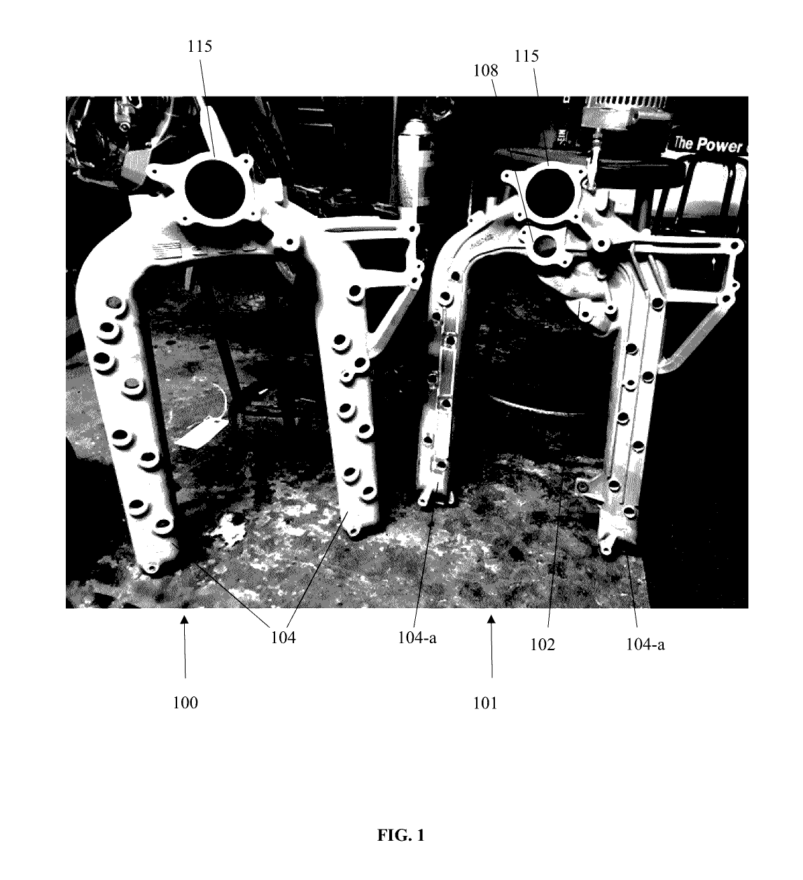

FIG. 1 illustrates the front view of a hollow intake manifold 100, and an intake manifold 101 as known in the art (“intake manifold,” or “stock intake manifold”), according to an aspect. A hollow intake manifold 100 may be provided with exhaust gas recirculation (EGR) components (“EGR components” or “smog components”), as shown by 102 in the stock intake manifold, removed. A hollow intake manifold 100 may be provided with a larger interior volume than that of an intake manifold 101 known in the art, and may have larger runners 104 (“runner,” “inlet runner,” or “intake runner”) than the runners 104-a of the stock intake manifold. The hollow intake manifold 100 may lack an EGR valve (as shown by 108) below the air intake valve 115. The hollow intake manifold 100 may be used for a diesel engine, for example.

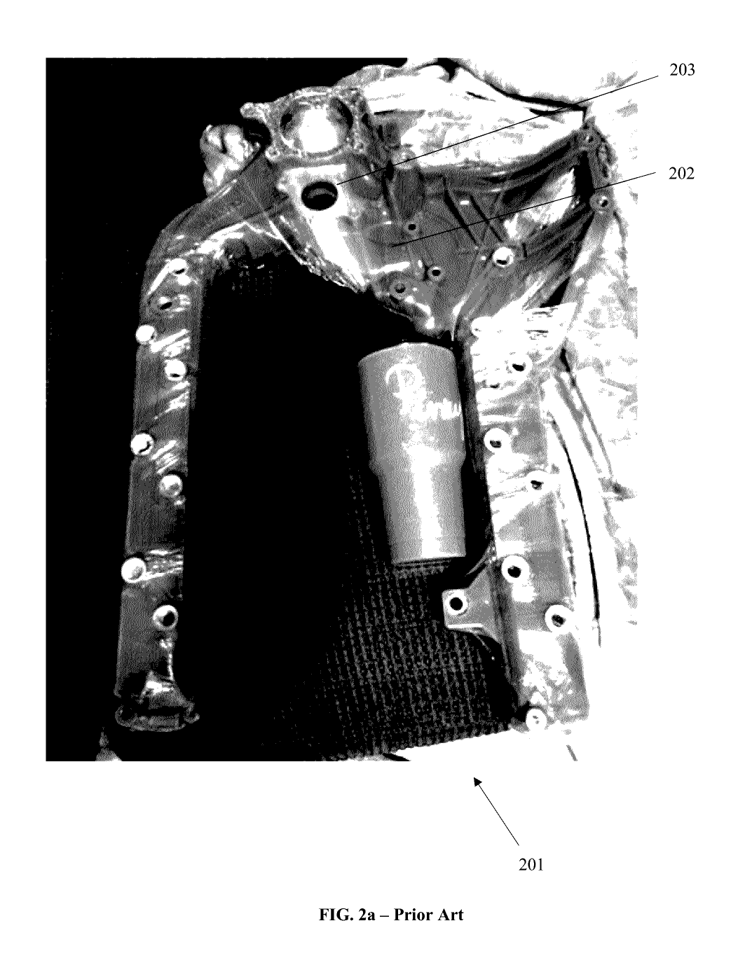

FIGS. 2a-2b show a front view and a front perspective view, respectively, of an intake manifold as known in the art, according to an aspect. The intake manifold 201 shows another example of a known intake manifold having EGR components 202, and an EGR valve 202. The EGR components may also partially be carried in the interior of the intake manifold, which may cause obstruction of air flow. An intake manifold such as the examples shown may also include inserts welded in to allow the intake manifold to be sealed, to prevent air leaks. FIG. 2a shows an intake manifold with EGR components still attached, and with the welded inserts, according to an aspect. FIG. 2b shows an intake manifold with welded inserts, at the top of the manifold, for use with a plug having an O-ring as a seal, according to an aspect. The hollow intake manifold may be used with similar diesel engines that the stock intake manifold may be used with, such as the following examples: 2003-2007 Ford 6.0 L Power Stroke engines (also provided by International and known as a VT 365 engine), the Ford 6.4 L Power Stroke engine, and 2008-2010 Ford 6.0 L Power Stroke engines. The hollow intake manifold may also be used for any other suitable diesel engine or any other suitable engine.

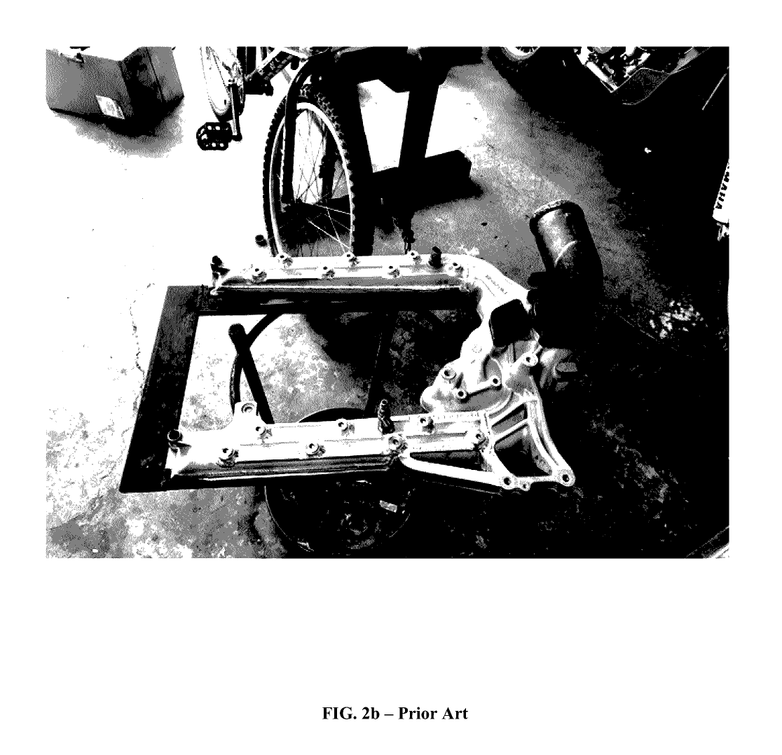

FIGS. 3a-3b show two examples of sectional views of a stock intake manifold 301 as known in the art, such as, for example, the stock intake manifolds shown in FIGS. 2a-2b, according to an aspect. The intake manifold 301 may have metal posts 305 (“post,” or “pillar”) on the interior running from end to end, which allow a bolt to be tightened without putting excess force on the top of the manifold. Through use, an intake manifold 301 may have buildup of debris and grime on the interior. The presence of the posts 305 may lead to obstruction of air inside of the intake manifold, and the buildup of grime on the posts 305 may lead to further obstruction of air. The posts 305 may be mostly solid, with a hole for receiving a bolt 306, and may go all the way through the interior of the manifold. The bolt 306 may allow the manifold to attach to the vehicle's cylinder heads. The bolt 306 may have a bolt head 306-a, and a bolt thread 306-b. To secure a stock intake manifold to an internal combustion engine, a bolt 306 having a long bolt thread 305-b may be needed, to pass through the pillar 305.

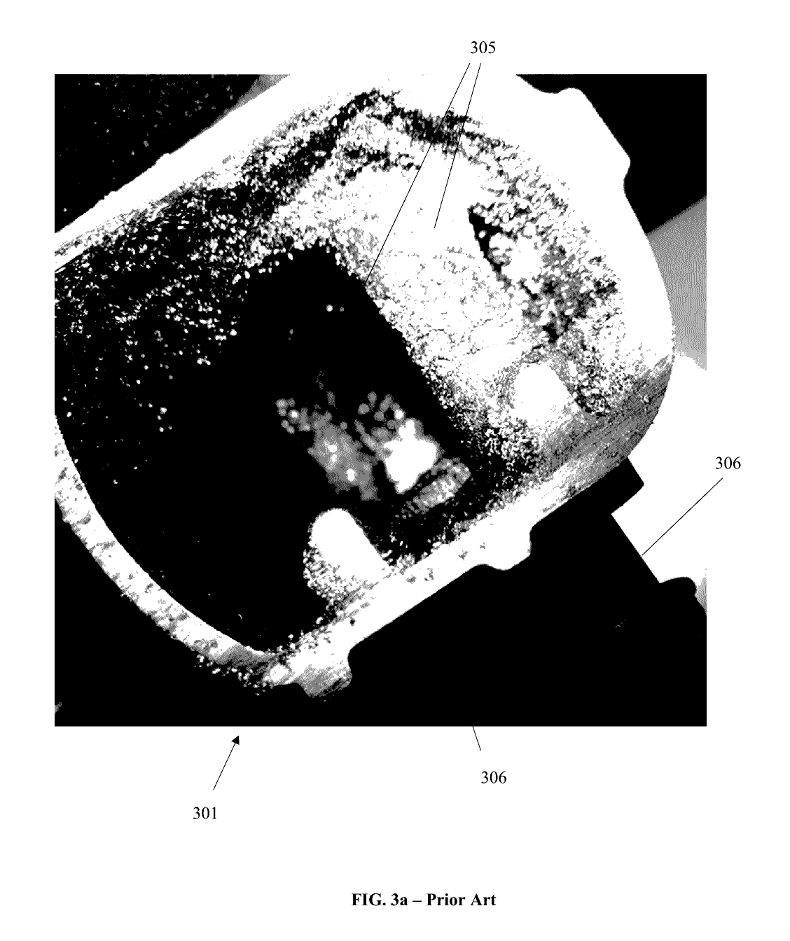

FIG. 4 shows a front perspective view of a hollow intake manifold 400, according to an aspect. The hollow intake manifold 400 may be provided without EGR components, and the internal volume of the hollow intake manifold may be larger than that of an intake manifold known in the art, having EGR components. A hollow intake manifold without pillars or posts in the interior, larger than a stock intake manifold, and having EGR components may also be provided. The hollow intake manifold may also be a similar size to a stock intake manifold, and may include EGR components. The hollow intake manifold may be bolted to the cylinder by bolts as shown as shown. In an intake manifold known in the art, there may be bolts running from the front surface of the intake manifold into the cylinder head, which may cause obstruction of air. In a hollow intake manifold,

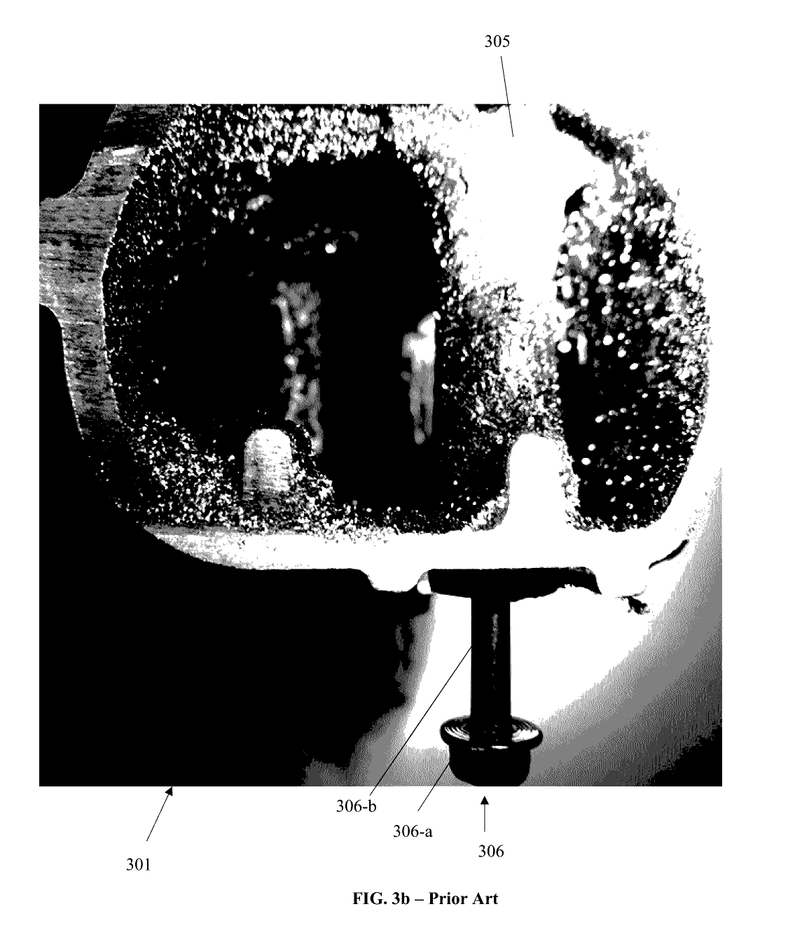

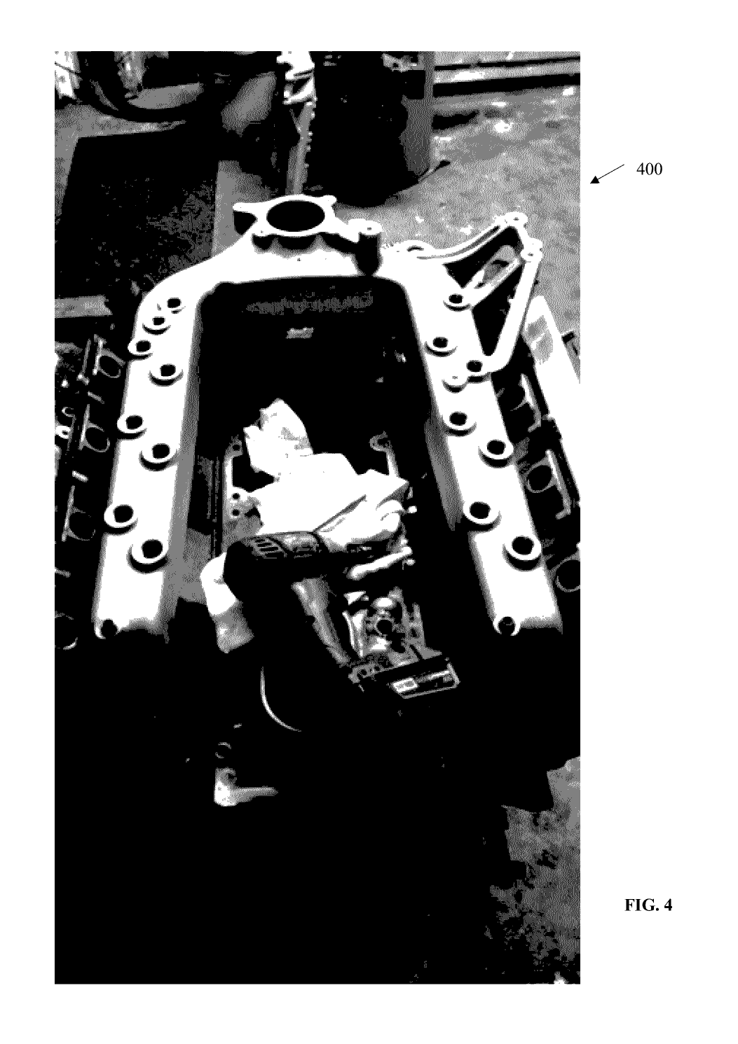

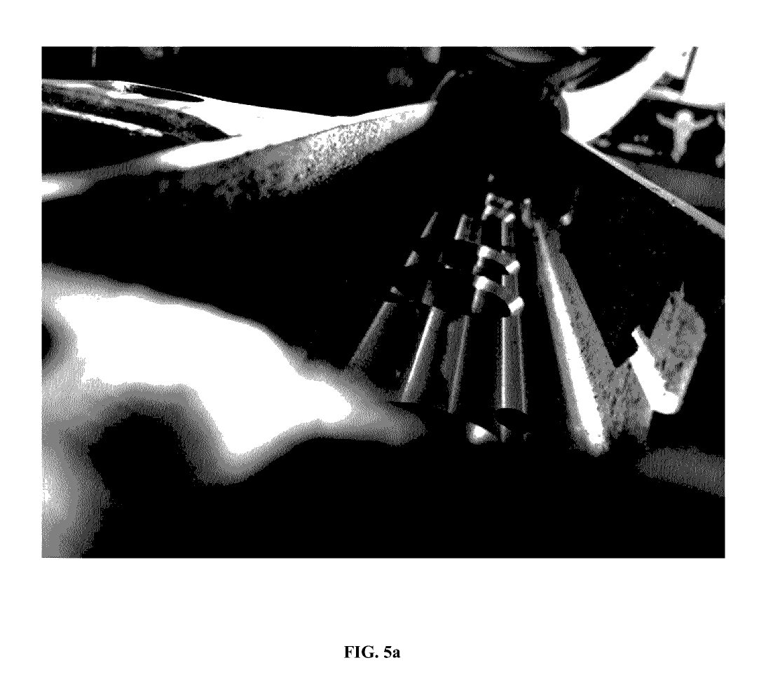

FIGS. 5a-5b show a perspective sectional view and a sectional view, respectively, of a hollow intake manifold, according to an aspect. FIG. 5a shows a stock intake manifold known in the art that may be modified to be hollow, by removal of the interior posts, according to an aspect. The posts, which obstructed the interior of the intake manifold known in the art (shown in FIGS. 3a-3b) may be removed from the interior of the hollow intake manifold manually, and the modified intake manifold may then be used for better engine performance. FIG. 5b shows another example of an intake manifold, a hollow intake manifold that may be custom built without interior bolts, according to an aspect. The bolts may be recessed or may be flush with the interior of the hollow intake manifold. Removal of the posts from the interior of the hollow intake manifold may allow for more free-flowing air throughout the inside of the manifold.

FIGS. 5c-5d show a perspective view and a detailed view, respectively, of a hollow intake manifold 500 with its runner cut open, displaying the interior, according to an aspect. Without pillars or posts, the intake manifold 500 is provided with a hollow interior space. To secure the intake manifold to the engine, the hollow intake manifold 500 may be bolted. Once bolted, the head 506-a of the bolt may rest on the inner floor 518 of the intake manifold such that no portion of the bolt thread is laying within the hollow interior space. As another example, the bolt may secure the intake manifold to the engine such that the bolt head 506-a is flush with the floor of the hollow interior space. A shorter bolt having a short bolt thread may be used for a hollow intake manifold than is needed for bolting a stock intake manifold. The inner floor of the hollow intake manifold may include cylinder head holes 507 for circulating the air/fuel mixture to the cylinder heads below.

FIG. 5e shows a detailed front perspective view of one of the hollow intake manifold's runners, according to an aspect. The front of the hollow intake manifold may include a plurality of access holes 509, such that a user may reach in with a tool for securing a bolt in the inner floor of the hollow intake manifold, using any suitable bolt-securing tool. Then, before use, the access holes may be sealed to prevent air leaks by any suitable means. As an example, the access holes may be plugged using a Society of Automotive Engineers (SAE) standard O-ring 510, such as an SAE #8 O-ring boss seal/plug. The access holes 509 may therefore include threading, as an example, for receiving a threaded seal. Access hole 509-a is shown sealed, and access hole 509 is shown unsealed.

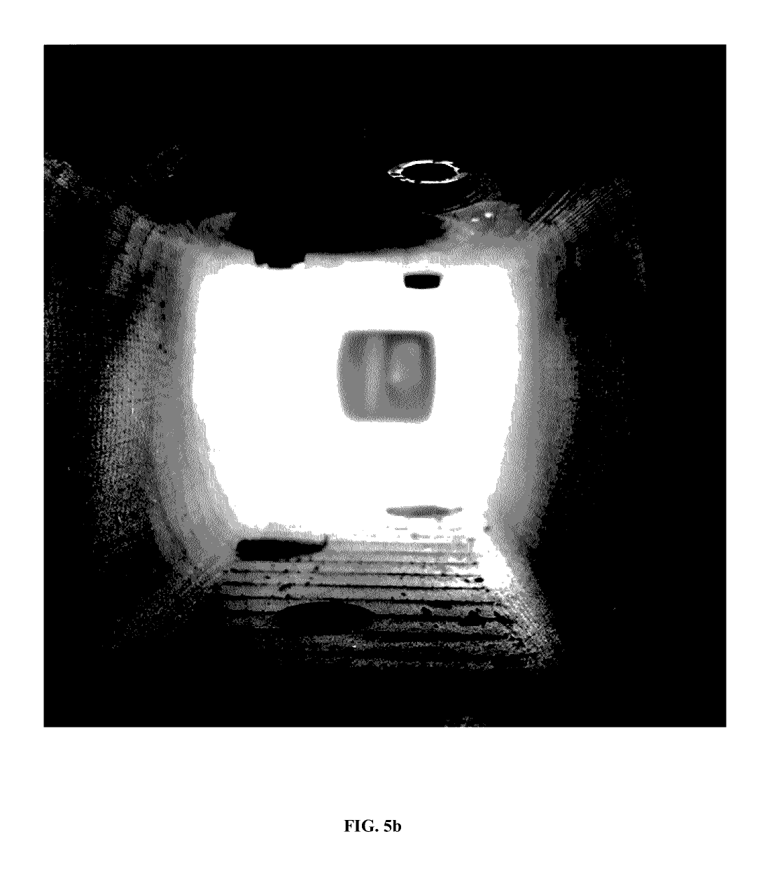

FIG. 6 illustrates the front plan view of another example of a hollow intake manifold 600, according to an aspect. Access holes 609 for installing the hollow intake manifold with bolts may be provided on the front side of the hollow intake manifold. The hollow intake manifold may be larger in size than a stock intake manifold. As an example, the hollow intake manifold may be approximately 21 and ⅝ inches from point 611 to the end point of a runner 612, while a stock intake manifold may be approximately 21 and ¼ inches between similar points. The width of one runner from point 612 to point 613 may be approximately 3¼ inches, while the width of one runner between similar points of a stock intake manifold may be approximately 3 and 1/16 inches.

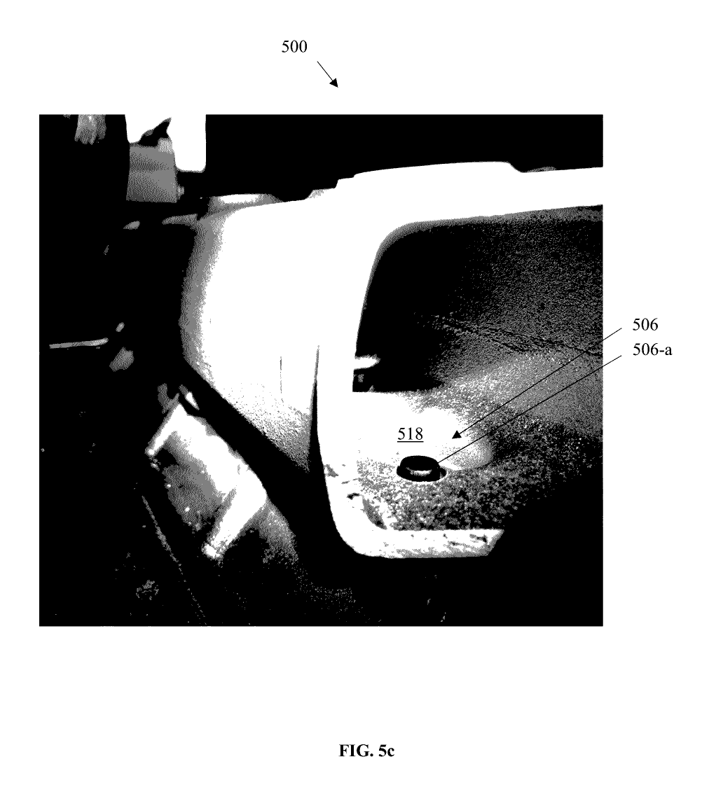

FIG. 7 illustrates the top elevation view of the hollow intake manifold 700 of FIG. 6, according to an aspect. The height 714 of a hollow intake manifold runner may be approximately 3 and 7/16 inches tall, while the height of a stock intake manifold runner may be approximately 3 and 1/16 inches tall.

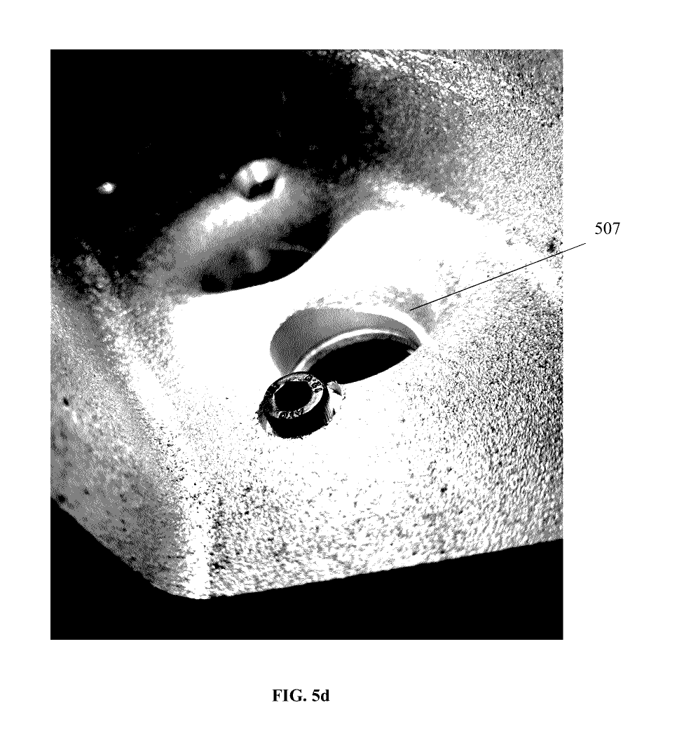

FIG. 8 illustrates the bottom elevation view of the hollow intake manifold 800 of FIG. 6, according to an aspect.

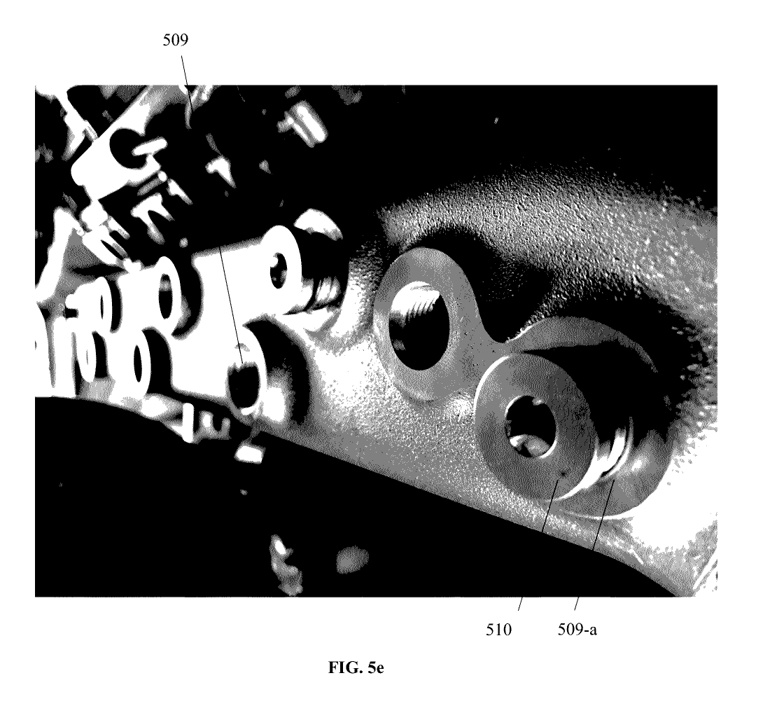

FIG. 9 illustrates the left side perspective view of the hollow intake manifold 900 of FIG. 6, according to an aspect.

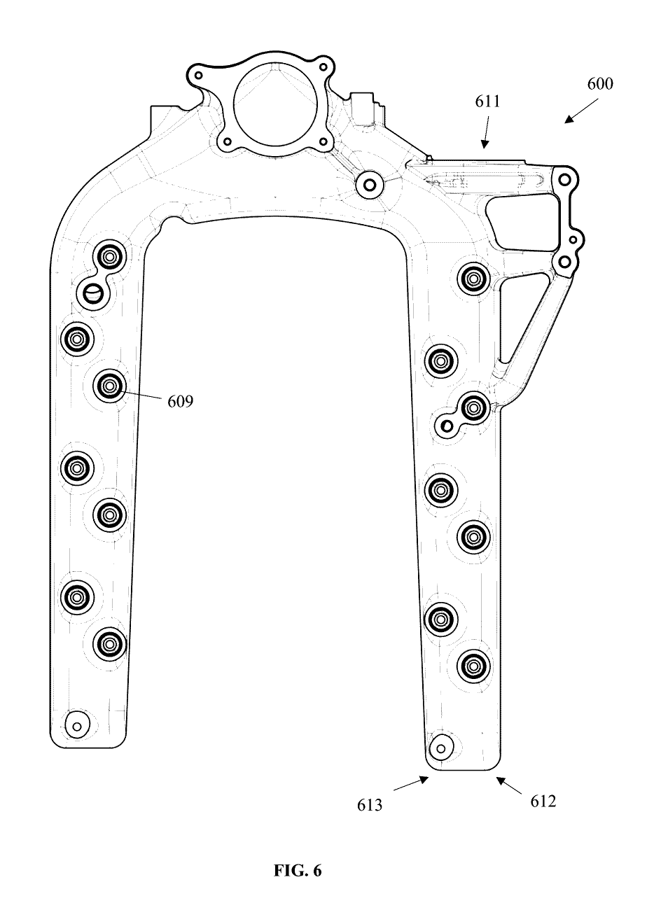

FIG. 10 illustrates the left side elevation view of the hollow intake manifold 1000 of FIG. 6, according to an aspect.

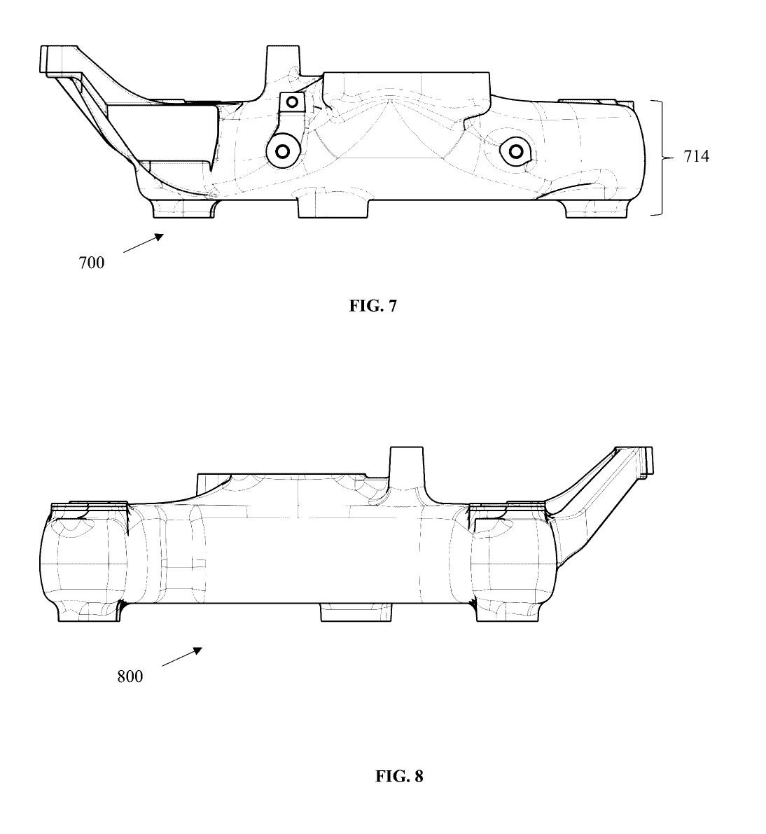

FIG. 11 illustrates the right side perspective view of the hollow intake manifold 1100 of FIG. 6, according to an aspect.

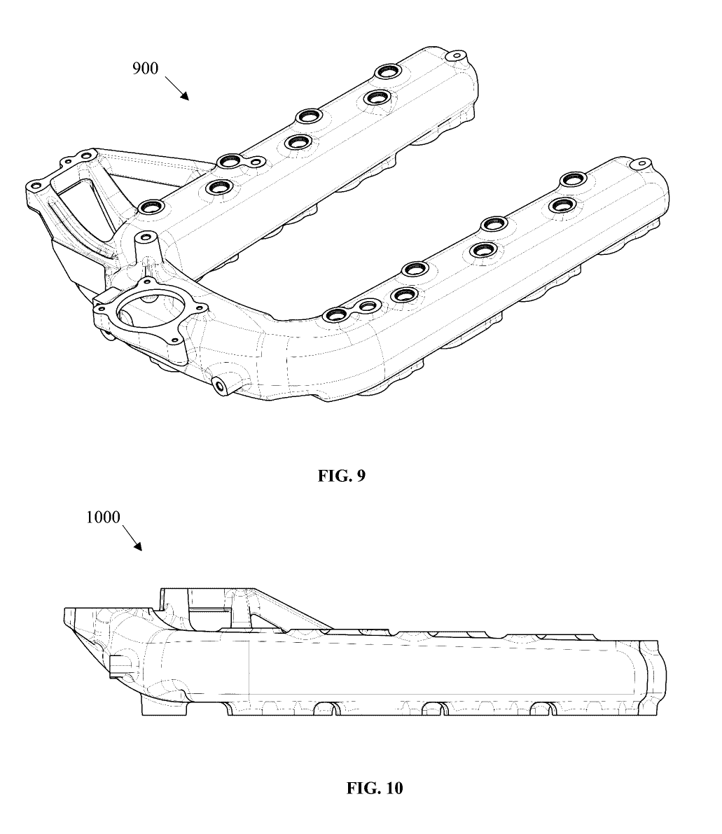

FIG. 12 illustrates the back right perspective view of the hollow intake manifold 1200 of FIG. 6, according to an aspect.

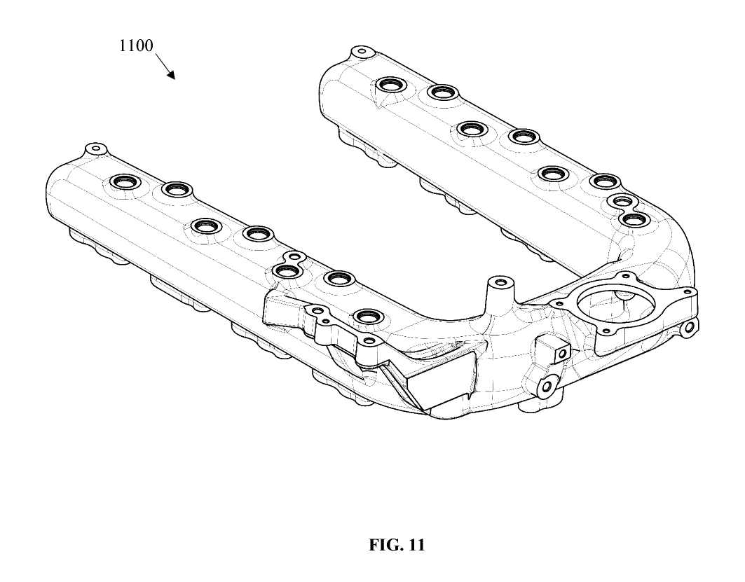

FIG. 13 illustrates the back plan view of the hollow intake manifold 1300 of FIG. 6, according to an aspect.

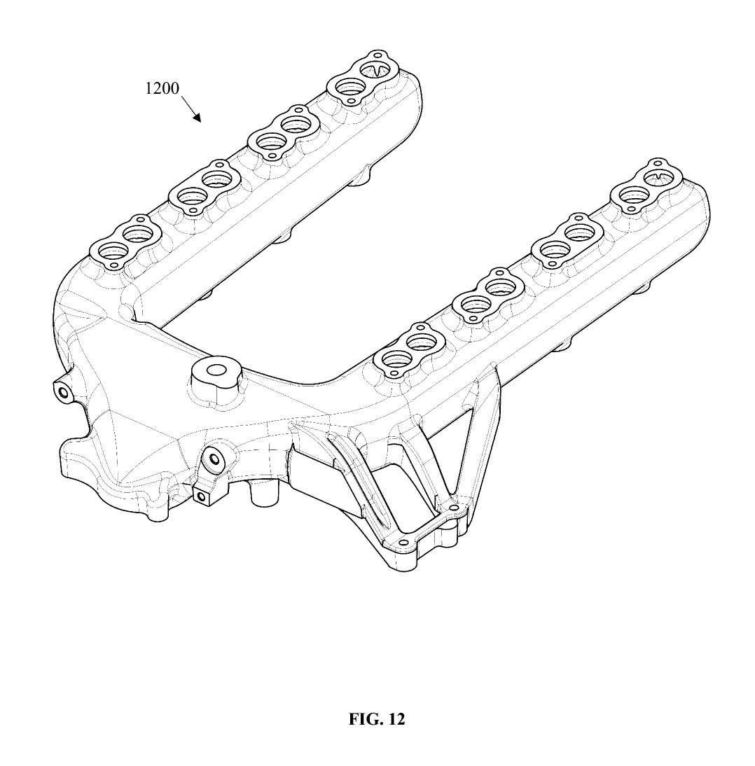

FIG. 14 illustrates the back left perspective view of the hollow intake manifold 1400 of FIG. 6, according to an aspect.

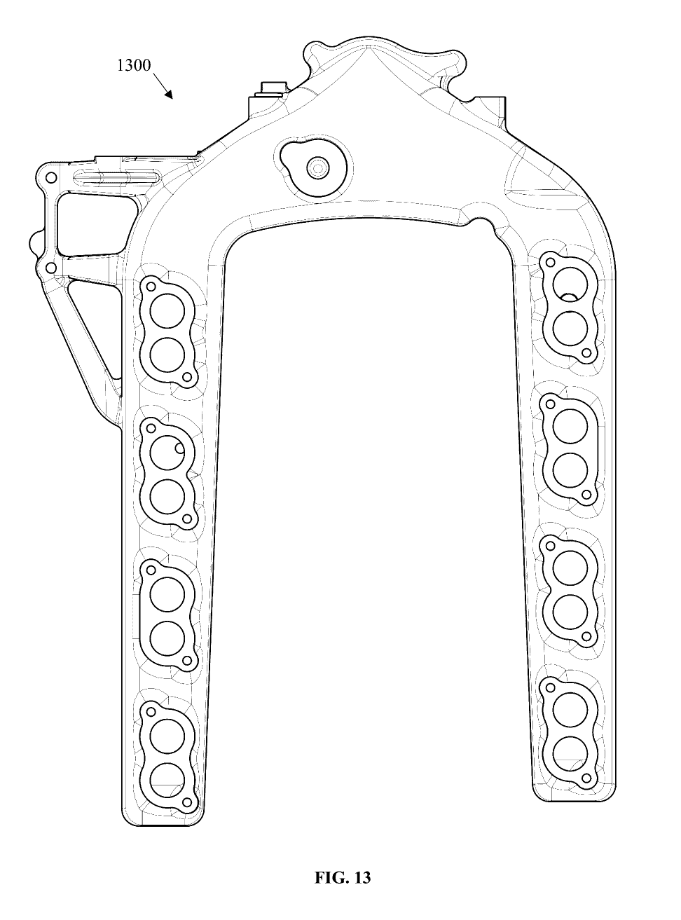

FIG. 15 shows a front perspective view of another example of a hollow intake manifold 1500, according to an aspect.

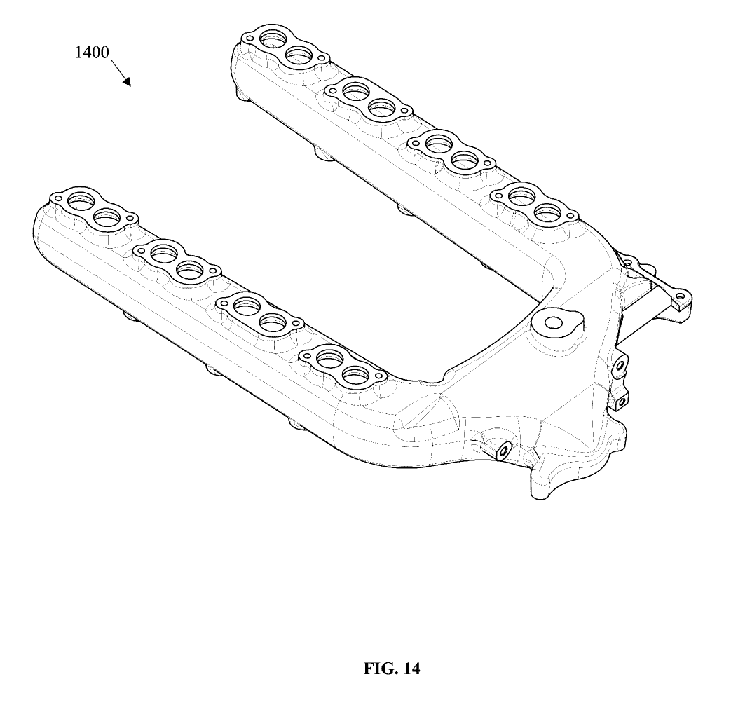

FIG. 16 shows the left side perspective view of the hollow intake manifold 1600 of FIG. 15, according to an aspect.

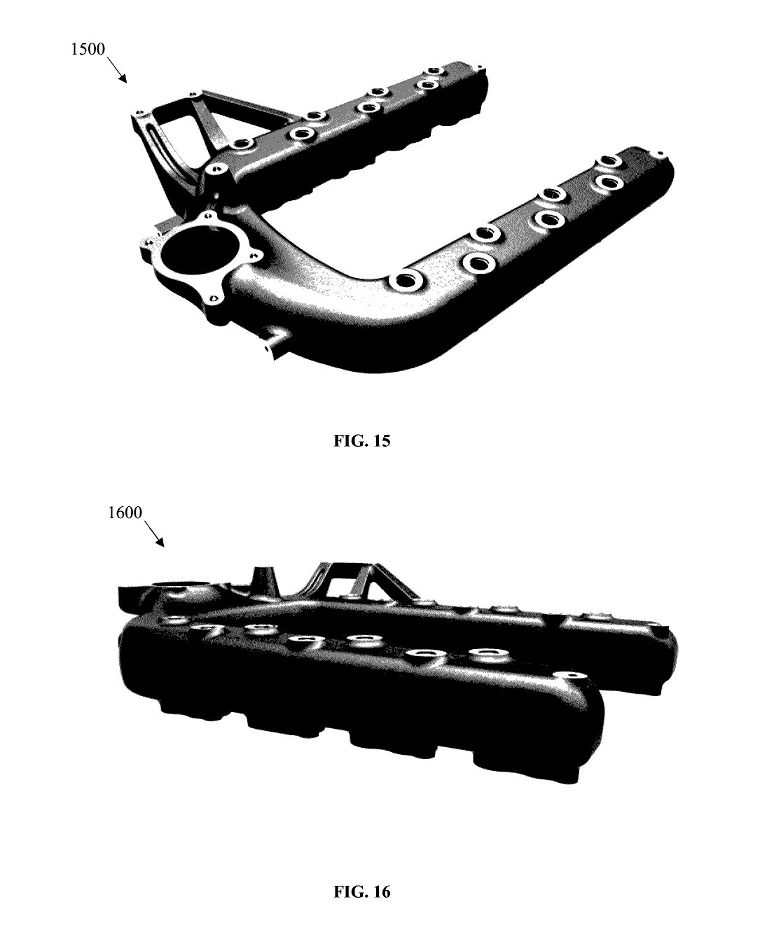

FIG. 17 shows the back perspective view of the hollow intake manifold 1700 of FIG. 15, according to an aspect.

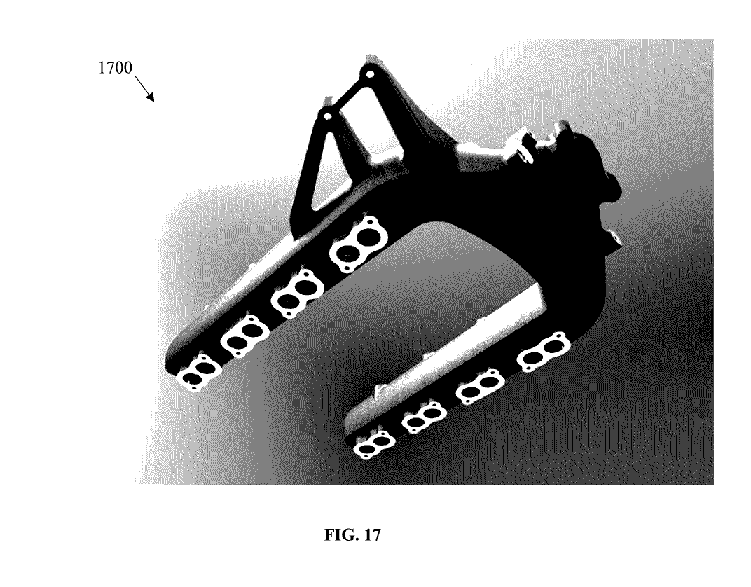

FIG. 18 shows the front top perspective view of the hollow intake manifold 1800 of FIG. 15, according to an aspect.

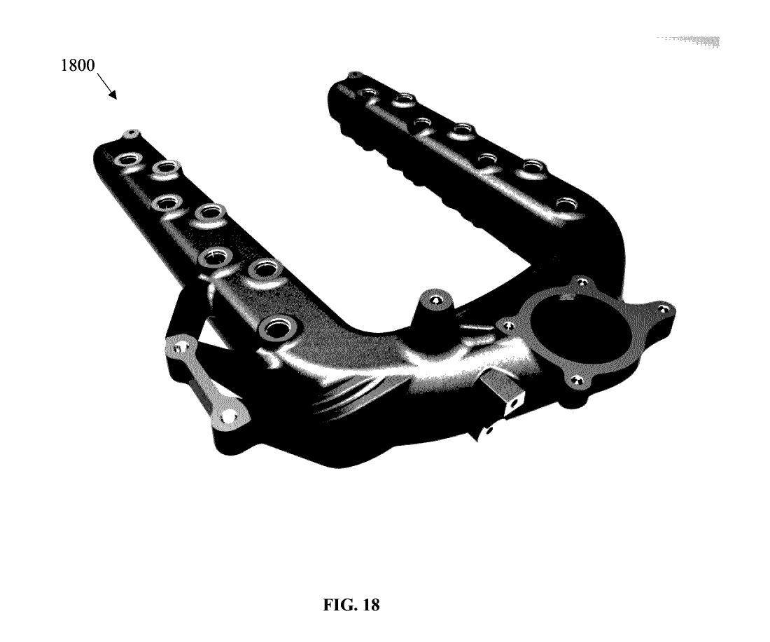

FIG. 19 shows the front side perspective view of the hollow intake manifold 1900 of FIG. 15, according to an aspect.

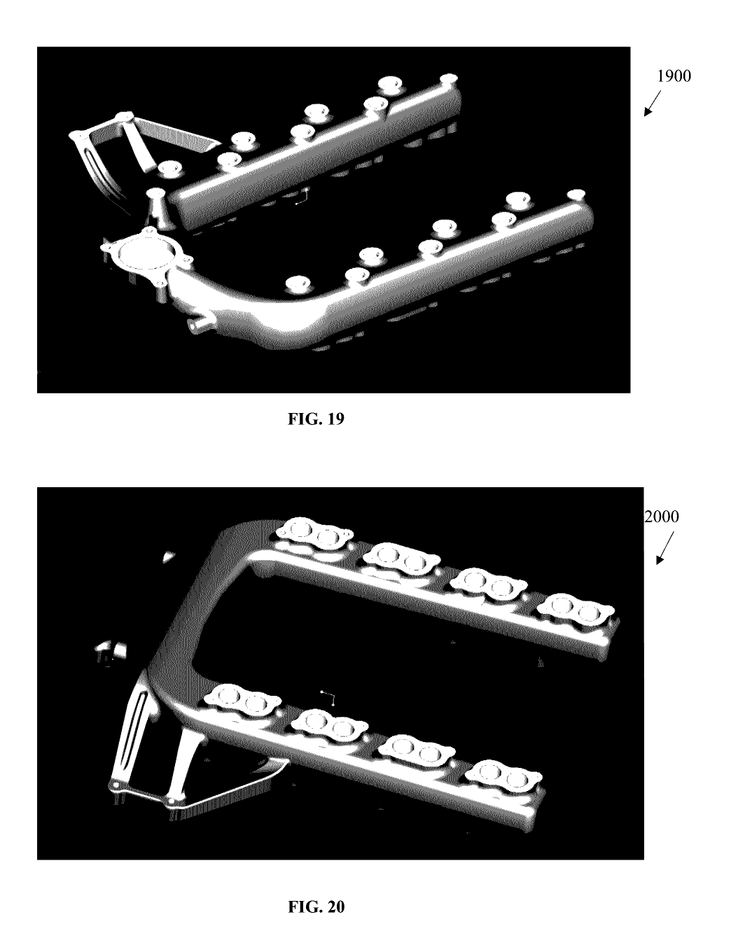

FIG. 20 shows the back side perspective view of the hollow intake manifold 2000 of FIG. 15, according to an aspect.

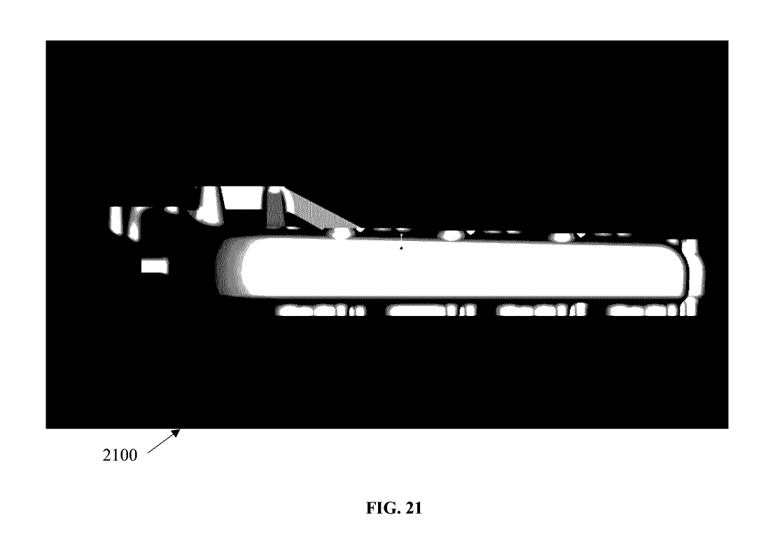

FIG. 21 shows the left side elevation view of the hollow intake manifold 2100 of FIG. 15, according to an aspect.

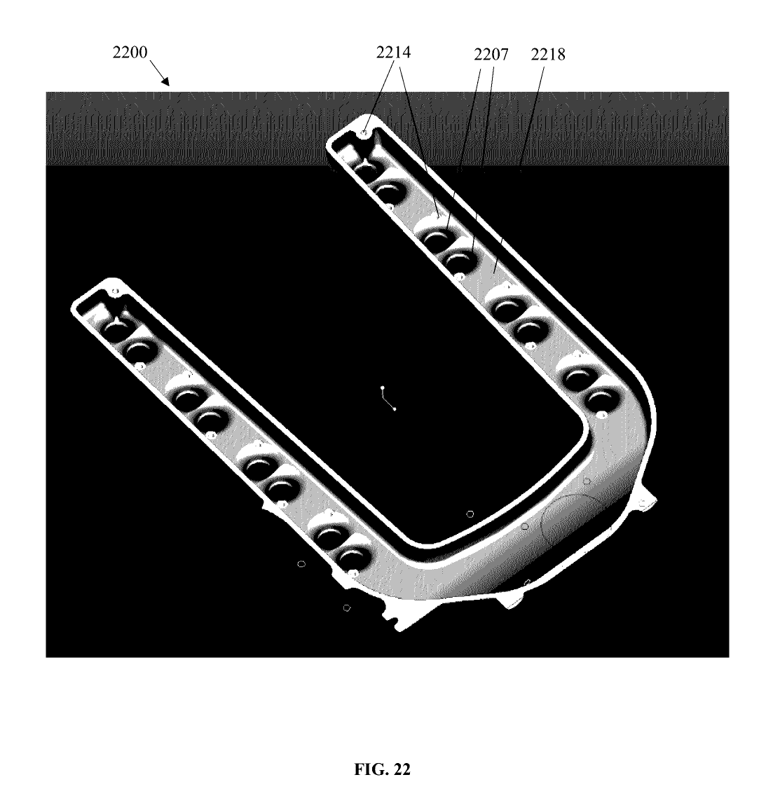

FIG. 22 shows the horizontal sectional view of the hollow intake manifold 2200 of FIG. 15, showing the inner floor 2218, according to an aspect. The interior of the hollow intake manifold may be free of any obstructions, and may eliminate posts or pillars that extend from the top to bottom of the interior of the intake manifold. The inner floor 2218 may include a plurality of cylinder head holes 2207 for delivering the air/fuel mixture to the engine cylinder heads. As an example, a hollow intake manifold may be used for a V8 engine, thus, eight cylinder head holes may be provided in each runner, for a total of sixteen cylinder head holes such that there are two cylinder head holes 2207 per each engine cylinder head, and the cylinder head holes correspond with the engine's cylinder head openings. Each pair of cylinder head holes 2207 may also be next to at least one bolt hole 2214. As shown, each pair of cylinder head holes 2207 may be next to two bolt holes 2214. Each runner may also include a bolt hole 2214 at its end.

It should be understood that an intake manifold of any design for any make or model of vehicle having an internal combustion engine may be suitably provided with a hollow interior, for improved engine performance.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. An intake manifold for an internal combustion engine comprising: at least one runner having a front side and a back side defining a hollow interior space, and a port for receiving air into the hollow interior space, the back side having a plurality of cylinder holes aligning with cylinder head openings of the internal combustion engine and a plurality of bolt holes configured for receiving a plurality of bolts, each bolt having a bolt head and a bolt thread, the front side having a plurality of access holes aligning with the plurality of bolt holes, the access holes being configured to allow a user to access and secure the bolt head using a bolt-securing tool, the access holes being further configured to receive a seal, such that the intake manifold can be secured to the internal combustion engine with no portion of the bolt thread lying within the hollow interior space of the intake manifold thus preventing obstruction of air circulation through the hollow interior space.

2. The intake manifold of claim 1, wherein the intake manifold can be secured to the internal combustion engine with no portion of the bolt head lying within the hollow interior space of the intake manifold.

3. The intake manifold of claim 1, comprising a left runner and a right runner, wherein the port for receiving air communicates with the hollow interior space of the left runner and the right runner.

4. The intake manifold of claim 1, wherein the access holes further comprise threading.

5. The intake manifold of claim 4, wherein the seal is an O-ring boss seal.

6. The intake manifold of claim 1, having no components for exhaust gas recirculation.

7. An intake manifold for an internal combustion engine comprising: at least one runner having a front side and a back side defining an interior space, the interior space having a hollow interior portion and an interior exhaust gas recirculation portion housing exhaust gas recirculation components, and a port for receiving air into the hollow interior portion, the back side having a plurality of cylinder holes aligning with cylinder head openings of the internal combustion engine and a plurality of bolt holes configured for receiving a plurality of bolts, each bolt having a bolt head and a bolt thread, the front side having a plurality of access holes aligning with the plurality of bolt holes, the access holes being configured to allow a user to access and secure the bolt head using a bolt-securing tool, the access holes being further configured to receive a seal, such that the intake manifold can be secured to the internal combustion engine with no portion of the bolt thread lying within the hollow interior portion of the intake manifold thus preventing obstruction of air circulation through the hollow interior portion.

8. The intake manifold of claim 7, wherein the intake manifold can be secured to the internal combustion engine with no portion of the bolt head lying within the hollow interior portion of the intake manifold.

9. The intake manifold of claim 7, comprising a left runner and a right runner, wherein the port for receiving air communicates with the hollow interior portion of the left runner and the right runner.

10. The intake manifold of claim 7, wherein the access holes further comprise threading.

11. The intake manifold of claim 10, wherein the seal is an O-ring boss seal.

12. The intake manifold of claim 7, having no components for exhaust gas recirculation.
